(19) United States
(12) Patent Application Publication
(10) Pub. No.: US 2026/0339487 A1
(43) Pub. Date: Oct. 29, 2026

(54) INFORMATION INTERACTION

(71) Applicant: Beijing Zitiao Network Technology Co., Ltd., Beijing (CN)

(72) Inventors: Yangming CAI, Beijing (CN); Linzhou LV, Beijing (CN); Tianlei ZHONG, Beijing (CN); Xinyi HAN, Beijing (CN); Changxin LIU, Beijing (CN); Fangfei YUE, Beijing (CN); Shengya ZHANG, Beijing (CN)

(21) Appl. No.: 19/658,331

(22) Filed: Apr. 24, 2026

(30) Foreign Application Priority Data
Apr. 25, 2025 (CN) 202510536513.2

(51) Int. Cl. G06F 3/0483; G06F 3/0484

(52) U.S. Cl. CPC G06F 3/0483; G06F 3/0484

(57) ABSTRACT

According to the embodiments of the disclosure, a method, an apparatus, a device, a storage medium and a program product for information interaction are provided. The example method includes: presenting, in a first interface, a plurality of tabs respectively corresponding to a plurality of topics, where the first interface includes a map view presenting at least one candidate point of interest mark; presenting, in response to a selection of a first tab from the plurality of tabs, at least one point of interest mark associated with a first topic corresponding to the first tab in the map view; and presenting, in association with respective point of interest marks of the at least one point of interest mark, topic indication information related to respective points of interest in the map view.

### CROSS-REFERENCE

The present application claims priority to Chinese Patent Application No.202510536513.2, filed on Apr. 25, 2025, and entitled "METHOD, APPARATUS, DEVICE, AND PROGRAM PRODUCT FOR INFORMATION INTERACTION ", which is incorporated herein by reference in its entirety.

### FIELD

Example embodiments of the present disclosure generally relate to the field of computers, and in particular, to information interaction.

### BACKGROUND

With the rapid development of Internet technologies, various applications have become important tools in people's daily lives. Users may interact with the applications according to their needs to obtain content or services provided by the applications. Therefore, it is desired to improve the manner of information interaction to enable the users to obtain more information and services of interest.

### SUMMARY

In a first aspect of the present disclosure, a method for information interaction is provided. The method includes: presenting, in a first interface, a plurality of interface elements respectively corresponding to a plurality of content items, the first interface including a map view presenting at least one candidate object; presenting, in response to a selection of a first interface element from the plurality of interface elements, at least one object associated with a first content item corresponding to the first interface element in the map view; and presenting, in association with respective objects of the at least one object, content item indication information related to respective points. of interest in the map view.

In a second aspect of the present disclosure, an apparatus for information interaction is provided. The apparatus includes: a first presenting module configured to present, in a first interface, a plurality of interface elements respectively corresponding to a plurality of content items, where the first interface includes a map view presenting at least one candidate object; a second presenting module configured to present, in response to a selection of a first interface element from the plurality of interface elements, at least one object associated with the first content item corresponding to the first interface element; and a third presenting module configured to present, in association with respective objects of the at least one object, content item indication information related to a respective object in the map view.

In a third aspect of the present disclosure, an electronic device is provided. The device includes at least one processor; and at least one memory coupled to the at least one processor and storing instructions executable by the at least one processor, the instructions, when executed by the at least one processor, causing the device to perform the method of the first aspect.

In a fourth aspect of the present disclosure, a computer-readable storage medium is provided. The computer-readable storage medium has a computer program stored thereon which is executable by a processor to implement the method of the first aspect.

In a fifth aspect of the present disclosure, a computer program product is provided. The program product includes a computer program which is executable by a processor to implement the method of the first aspect.

It would be appreciated that the content described in the Summary section of the present disclosure is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent when taken in conjunction with the drawings and with reference to the following detailed description. In the drawings, the same or similar reference numbers refer to the same or similar elements, where:

FIG. 1 shows a schematic diagram of an example environment in which embodiments according to the present disclosure may be implemented;

FIGS. 2A-2G show example interfaces for information interaction according to some embodiments of the present disclosure;

FIGS. 3A-3C show example interfaces for virtual resource acquisition based on historical interaction information according to some embodiments of the present disclosure;

FIG. 4 shows a flowchart of an example process for information interaction according to some embodiments of the present disclosure;

FIG. 5 shows a schematic structural block diagram of an example apparatus for information interaction according to some embodiments of the present disclosure; and

FIG. 6 shows a block diagram of an electronic device capable of implementing multiple embodiments of the present disclosure.

### DETAILED DESCRIPTION

The embodiments of the present disclosure will be described in more detail below with reference to the drawings. Although some embodiments of the present disclosure are shown in the drawings, it would be appreciated that the present disclosure may be implemented in various forms and should not be construed as limited to the embodiments set forth herein. On the contrary, these embodiments are provided for a more thorough and complete understanding of the present disclosure. It would be appreciated that the drawings and embodiments of the present disclosure are only for illustrative purposes, and are not intended to limit the protection scope of the present disclosure.

It would be noted that the titles of any section/sub-section provided herein are not restrictive. Various embodiments are described throughout this article, and any type of embodiment may be included under any section/sub-section. Furthermore, the embodiments described in any section/sub-section may be combined with any other embodiments described in the same section/sub-section and/or different section/sub-section in any manner.

In the description of the embodiments of the present disclosure, the term "include/comprise" and similar terms thereto should be understood as open-ended inclusions, that is, "include/comprise but not limited to". The term "based on" should be understood as "at least partially based on". The term "one embodiment" or "the embodiment" should be understood as "at least one embodiment". The term "some embodiments" should be understood as "at least some embodiments". The following may also include other explicit and implicit definitions. The terms "first", "second", etc. may refer to different or same objects. The following may also include other explicit and implicit definitions.

The embodiments of the present disclosure may involve user's data, data acquisition, and/or data use, etc. These aspects all comply with the corresponding laws, regulations, and related provisions. In the embodiments of the present disclosure, all data collection, acquisition, processing, machining, forwarding, use, etc. are performed on the premise that the user is aware and confirms. Accordingly, when implementing the embodiments of the present disclosure, the user should be informed of the type, use scope, use scenarios, etc., of data or information that may be involved, and the authorization of the user should be obtained, in an appropriate manner in accordance with relevant laws and regulations. The specific manner of informing and/or authorizing may vary according to actual situations and application scenarios, and the scope of the present disclosure is not limited in this regard.

If the solutions in the specification and embodiments involve personal information processing, the processing will be performed on the premise that there is a legal basis (for example, the consent of the personal information subject is obtained, or it is necessary for the performance of a contract, etc.), and the processing will only be performed within the scope of provisions or agreements. If a user refuses to process personal information other than the necessary information required for a basic function, it will not affect the user's use of the basic function.

As mentioned above, users may interact with applications to obtain different information or services. For example, in the interface interaction of applications, a map view may be presented to a user in a specific interface, and multiple points of interest and corresponding information are marked in the map view, so that the user may understand the corresponding points of interest in more detail. At present, most applications determine the points of interest to be presented in a map based on the historical itinerary of a user, for example, the points of interest that the user has visited. However, this manner cannot provide the user with information related to the points of interest that the user has not visited, and cannot provide the presentation of the set of points of interest organized according to a certain classification, thus impeding the user's exploration of the surrounding environment.

The embodiments of the present disclosure propose a solution for information interaction. In this solution, a plurality of tabs respectively corresponding to a plurality of topics are presented in a first interface, where the first interface includes a map view presenting at least one candidate point of interest mark. If a selection of a first tab from the plurality of tabs is detected, at least one point of interest mark associated with a first topic corresponding to the first tab is presented in the map view. In the map view, topic indication information related to respective points of interest is presented in association with the respective points of interest mark of the at least one point of interest mark.

Through the embodiments of the present disclosure, based on the user's selection of a tab, a point of interest (that is, a location in the map) associated with the topic corresponding to the tab selected by the user is determined from the candidate points of interest. The corresponding point of interest mark is presented in the map view according to the location of the point of interest, and the topic indication information related to the point of interest is presented. In this manner, based on the tab selected by the user, the point of interest mark and the corresponding topic indication information related to the user's selection may be presented to the user. Accordingly, the user may be provided with the corresponding point of interest and the topic indication information related to the point of interest according to the user's needs, to help the user know the related topic information at different locations.

Various example implementations of this solution are described in detail below with reference to the drawings.

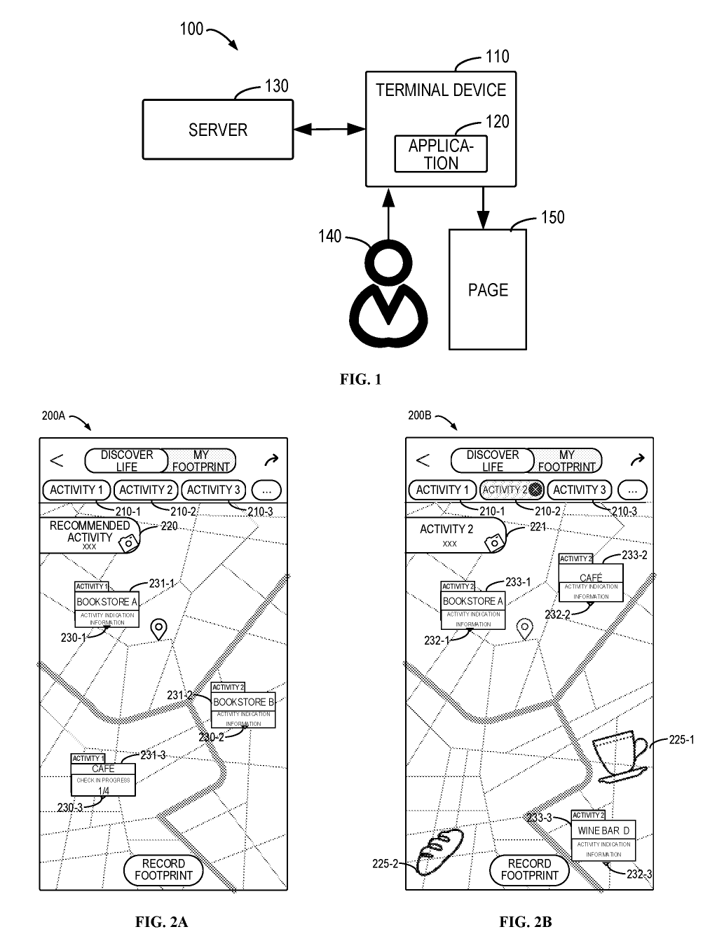

FIG. 1 shows a schematic diagram of an example environment 100 in which the embodiments of the present disclosure may be implemented. In this example environment 100, an application 120 is installed in a terminal device 110. A user 140 may interact with the application 120 via the terminal device 110 and/or an attachment device of the terminal device 110.

In some embodiments, the application 120 may be a content sharing application, a content editing application, a content creation application, etc. The application 120 may provide the user 140 with various services related to media content (which may also be referred to as media content items, content items, media items, etc.), including browsing, commenting, forwarding, creating (for example, shooting and/or editing), posting, etc., of the media content.

In the environment 100 of FIG. 1, if the application 120 is in an active state, the terminal device 110 may present the interface 150 of the application 120. The interface 150 may include various interfaces that may be provided by the application 120, such as an object (for example, a commodity) presentation interface, a recommendation interface, a media content presentation interface, a media content creation interface, a media content posting interface, etc. The application 120 may provide an interaction function associated with an object (for example, the application 120 may be an interaction-type application) to support browsing of the object or interaction operations associated with the object in the application 120.

In some embodiments, the terminal device 110 may communicate with a server to enable the provision of the services of the application 120. The terminal device 110 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination of the above, including the accessories and peripherals of these devices or any combination thereof. In some embodiments, the terminal device 110 may also support any type of user-oriented interface (such as a "wearable" circuit, etc.). The server may be various types of computing systems/servers capable of providing computing power, including but not limited to mainframes, edge computing nodes, computing devices in cloud environments, etc.

It would be appreciated that the structure and function of each element in the environment 100 are described only for the purpose of illustration, and do not imply any limitation on the scope of the present disclosure.

Various example implementations of the present disclosure will be described in detail below with reference to the drawings. It would be appreciated that the pages shown in the drawings are only examples, and there may be various page designs in practice. Each graphic element in a page may have different arrangements and different visual representations, one or more of which may be omitted or replaced, and there may also be one or more other elements. The embodiments of the present disclosure are not limited in this regard. In addition, in the following, the example embodiments will be described mainly with respect to the terminal device 110. It would be appreciated that the actions described with respect to the terminal device 110 may be performed by the application 120 on the terminal device 110, or may be performed by the application 120 in cooperation with its server (for example, a server).

Some example embodiments of the present disclosure will be described below with continued reference to the drawings.

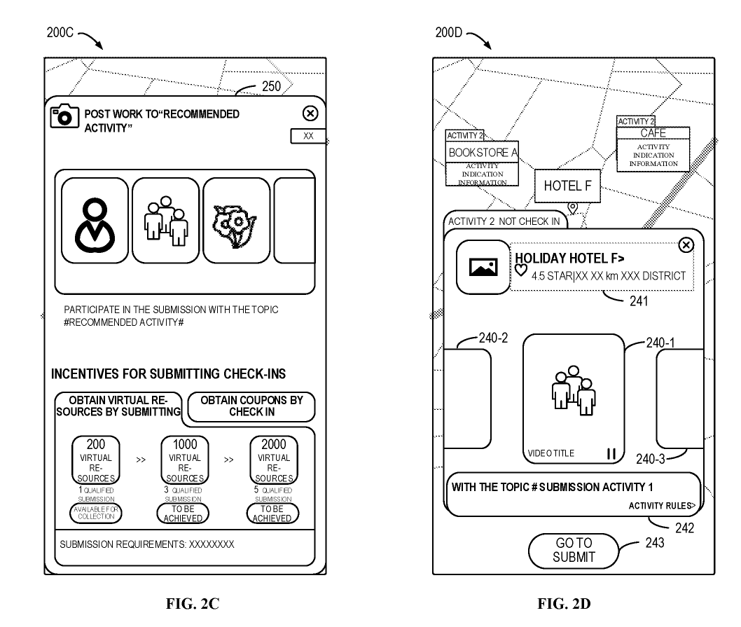

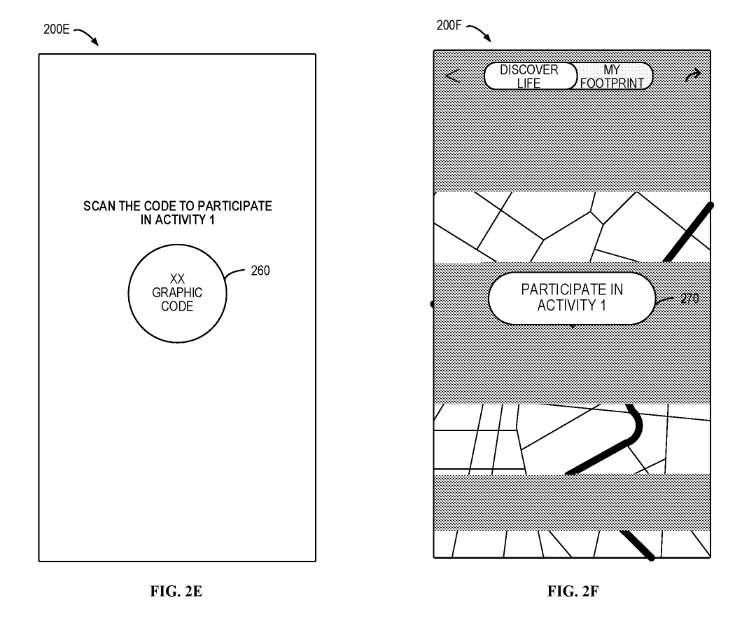

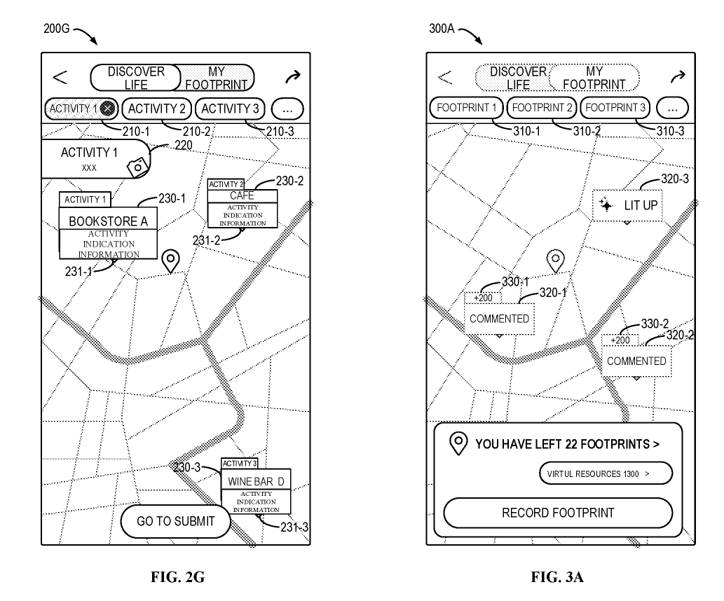

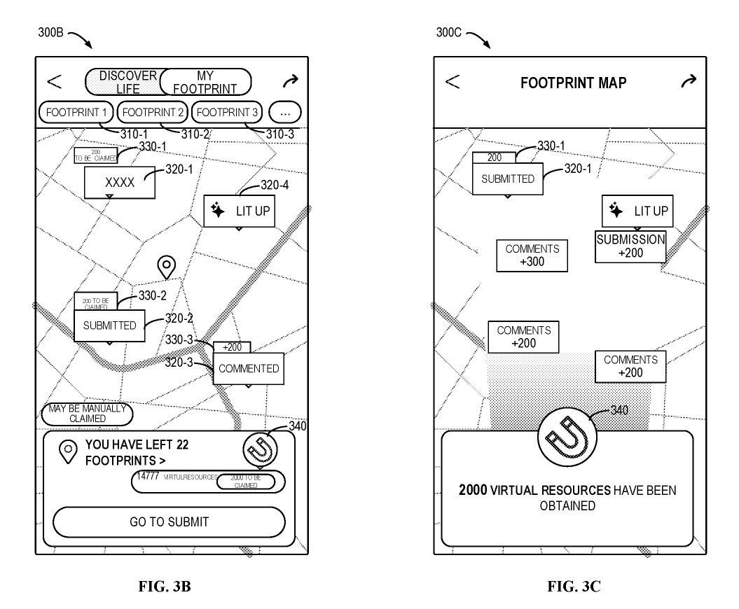

FIGS. 2A-3C show example interfaces 200A to 300C according to some embodiments of the present disclosure. The interfaces 200A to 300C may be provided, for example, by the terminal device 110 shown in FIG. 1. In the embodiments of the present disclosure, the example interfaces 200A to 300C show a plurality of instances of the application interface. The terminal device 110 may receive an operation from an associated user 140 for interaction, to present a corresponding interaction result.

In some embodiments, the terminal device 110 may present, in a first interface of the application 120, a plurality of tabs respectively corresponding to a plurality of topics. As shown in FIG. 2A, the first interface shown in the example interface 200A may include a map view. The example interface 200A may include a first tab 210-1, a second tab 210-2, and a third tab 210-3, which may also be collectively or individually referred to as a tab 210. The plurality of tabs correspond to a plurality of different topics, and may indicate a topic or an activity name. By way of example, the first tab may correspond to activity 1 (for example, a cafe photo-taking activity), the second tab 210-2 may correspond to activity 2 (for example, a bookstore photo-taking activity), and so on. In some embodiments, the tab 210 presented in the first interface may be determined by an operator, or may be automatically determined based on an attribute analysis of multiple locations. Note that although a certain number of tabs are shown in FIG. 2A, the number of tabs that may actually be presented and the specific activity name may be configured according to application needs.

Herein, each of the plurality of topics may indicate a specific activity. For example, the topic "coffee" may indicate a cafe photo-taking activity. Further, an "activity" herein refers to a specific event actively participated by a subject corresponding to different points of interest, or a classification of related attributes of the points of interest based on some selection rules. For example, some users or organizations, such as shops, parks, etc., may initiate various activities to invite users to participate, or various activities initiated by individual users. For another example, if some points of interest are marked by more users as related to a specific activity, the activity related to these points of interest may also be classified into one tab. As will be discussed below, the display of the tab is to help the user select a point of interest of interest from the map. In the embodiments of the present disclosure, topic and activity are used interchangeably.

As shown in FIG. 2A, the example interface 200A may include a map view, and the map view may present a map of an area specified by the user, or present a map of the area where the user is located. In the map view, at least one candidate point of interest mark is presented. A point of interest refers to a record of a location on the map that is considered useful or interesting, which is usually defined by its geographic coordinates and some additional attributes, which generally include a name, an address, a category, etc. The location marked by the candidate point of interest mark in the map view is the actual location of the corresponding candidate point of interest. In the embodiments of the present disclosure, when presenting the first interface, in addition to providing the tab corresponding to the topic, several points of interest that are selected by default are also presented in the map view. These candidate points of interest that are selected by default may indicate the locations that the user may want to explore in the map area, such as photo check-in points, shops, etc.

For example, the example interface 200A of FIG. 2A presents a candidate point of interest 230-1, a candidate point of interest 230-2, and a candidate point of interest 230-3, which may be collectively or individually referred to as a candidate point of interest 230. Certainly, the number and location of the points of interest shown in FIG. 2A and the subsequent example interfaces are for the purpose of illustration. In some embodiments, as the user drags the map view to move to different areas, the points of interest presented therein may also change accordingly.

In some embodiments, the candidate point of interest 230 may include all the locations in the presented map area. In some embodiments, the candidate point of interest 230 may be a location selected from all the locations according to a selection condition (for example, based on the popularity of the point of interest, based on the distance, etc.). In some embodiments, the candidate point of interest may be a point of interest related to a predetermined topic. The predetermined topic may be a topic that the application 120 expects to push to the user in a certain period of time or in a certain state, which is also referred to as a recommended topic or a default topic. In some embodiments, the candidate point of interest may be a point of interest related to a basic topic. The basic topic may be a topic that the application 120 supports the user to participate in for a long time. By way of example, in a certain push cycle (for example, four quarters), the application 120 may provide the user with the same basic topic in all four quarters, and provide the user with a predetermined topic corresponding to a respective quarter in each quarter. In a certain quarter, the user is provided with a plurality of topics and tabs corresponding to the plurality of topics, so as to facilitate the user's selection.

In some embodiments, the first interface may further include an interaction element for viewing a topic. By way of example, a first interaction element 220 related to the predetermined topic may be presented in the example interface 200A. If it is detected that the user triggers the first interaction element 220 (for example, clicks on the first interaction element), a second interface related to the predetermined topic is presented. The second interface includes detailed information for the predetermined topic. In some embodiments, the second interface may include detailed information for the predetermined topic, such as a participation manner of the recommended activity, rewards of the recommended activity, and media content related to the recommended activity. As shown in FIG. 2C, the example interface 200C includes a second interface 250, and the second interface includes media content (for example, an image or a video, etc.) for the predetermined topic, a participation manner of the predetermined topic (that is, participating in the submission with a certain topic), and incentives (for example, virtual resources such as coupons and points) that may be obtained by participating in the predetermined topic. In this manner, the user may view the detailed information of the corresponding topic by interacting with the first interaction element.

In some embodiments, when at least one candidate point of interest mark is presented in the map view, topic indication information related to respective candidate points of interest may also be presented in the map view in association with the respective candidate point of interest marks. The topic indication information may indicate activity indication information related to the corresponding activity. In the example interface 200A, the topic indication information may include first topic indication information 231-1, second topic indication information 231-2, and third topic indication information 231-3, which may be collectively or individually referred to as topic indication information 231. In some embodiments, the topic indication information 231 indicates information related to the topics corresponding to the respective candidate points of interest. In some embodiments, the topic indication information 231 related to each candidate point of interest 230 (or point of interest) may indicate activity indication information related to the candidate point of interest. By way of example, the activity indication information may include historical interaction information related to the candidate point of interest (for example, several people have interacted with the candidate point of interest, for example, checked in at the point of interest or participated in the activity corresponding to the point of interest). The topic indication information 231 may also indicate the topic related to the candidate point of interest, such as the topic or activity name, the number of people participating in the topic or activity, etc. In some embodiments, the topic indication information 231 may also indicate the participation state of the current user in the topic related to the candidate point of interest, for example, whether the user has participated or not, or the topic participation progress or state of the user (for example, the number of times the user has participated in a certain topic), etc. In some embodiments, the topic indication information 231 may also include attribute information related to the candidate point of interest, for example, the name of the candidate point of interest, the evaluation of the candidate point of interest, etc. The topic indication information 231 corresponding to different candidate points of interest 230 may be different.

In some embodiments, if the selection of a first tab from the plurality of tabs 210 is detected, at least one point of interest mark associated with a first topic corresponding to the first tab is presented in the map view. The first tab may be any tab of the plurality of tabs 210. In this embodiment, the tab 210-2 is taken as an example to illustrate the solution. As shown in FIG. 2B, if the selection of the tab 210-2 is detected, the activity 2 corresponding to the tab 210-2 is first determined. Then, the point of interest that participates in the activity 2 is determined from all the points of interest included in the map. The point of interest mark corresponding to the point of interest that participates in the activity 2 is presented in the map view of the interface 200B, as the point of interest mark associated with the first topic. The example interface 200B includes a first point of interest mark 232-1, a second point of interest mark 232-2, and a third point of interest mark 232-3, which correspond to the activity 2, and which may be collectively or individually referred to as a point of interest mark 232. The point of interest corresponding to the point of interest mark 232 may include some candidate points of interest. In this manner, the point of interest that meets the user's requirements is presented to the user.

In some embodiments, in the case of presenting the point of interest marks 232 corresponding to the first tab, the point of interest marks corresponding to the reference topic or the point of interest marks corresponding to the predetermined topic may also be presented in the map view. By way of example, whether to present the point of interest mark corresponding to other topics may be determined based on a topic rule related to the first topic. If the topic rule indicates that the first topic matches the reference topic, one or more point of interest marks associated with the reference topic are also presented in the map view while presenting the at least one point of interest mark associated with the first topic. For example, if the activity 1 corresponds to the activity 1, and the topic rule of the activity 1 includes two levels, the point of interest related to the reference activity corresponding to the reference topic and the point of interest related to the first activity corresponding to the first topic may participate in the first level activity, and the point of interest corresponding to the first activity may participate in the second level activity, then the point of interest related to the reference activity and the point of interest related to the first activity may be presented in the map view at the same time. In some embodiments, the first topic matching the reference topic indicates that based on a predetermined rule, the reference activity corresponding to the reference topic is allowed or suitable to be displayed in the map view together with the first activity corresponding to the first topic.

In some embodiments, as shown in FIG. 2B, if it is detected that the user selects a certain tab, the tab is highlighted so that the user may view the tab conveniently. The highlighted tab further includes a cancel control, and if it is detected that the user selects the cancel control for a certain tab, the point of interest mark corresponding to the tab is no longer presented, and the candidate point of interest mark is presented. In some embodiments, if it is detected that the user selects another tab, the point of interest mark corresponding to the tab that is selected by the user last is presented.

In some embodiments, the presentation style of the first interface may be determined based on user requirements, so as to facilitate the user to view information. If it is detected that the user selects a certain tab (for example, the tab 210-2) from the plurality of tabs, the activity 2 corresponding to the tab 210-2 and the theme style corresponding to the activity 2 are determined. Then, the first interface is presented based on the determined theme style. In some embodiments, the theme style may include corresponding theme elements. By way of example, if the activity 2 is a topic related to a "cafe", the coffee-related theme style may include a coffee cup 225-1 and a piece of bread 225-2, which may be collectively or individually referred to as a theme element 225. In some embodiments, the theme style may indicate an interface background. By way of example, if the activity 2 is a topic related to "flower viewing", a flower-related theme element is added to the background of the first interface and the background color of the first interface is made pink. Certainly, these are only some examples. In some embodiments, the theme style corresponding to the activity 2 may be determined from a plurality of theme styles, or the theme style related to the activity 2 may be generated by using a machine learning model, which is not limited in the embodiments of the present disclosure.

In some embodiments, in response to the selection of the first tab of the plurality of tabs, the first interaction element 220 is updated, in the first interface, to a second interaction element 221 related to the first topic. As shown in FIG. 2B, if it is detected that the user selects the tab 210-2, the first interaction element 220 is updated to the second interaction element 221 related to the activity 2.

In some embodiments, for a specific topic selected by the user, the terminal device 110 presents, in association with respective point of interest marks of the at least one point of interest mark, topic indication information related to respective points of interest in the map view. In the example interface 200B, the corresponding topic indication information is presented at each point of interest mark 232. The example interface 200B includes first topic indication information 233-1, second topic indication information 233-2, and third topic indication information 233-3, which may be collectively or individually referred to as topic indication information 233.

In some embodiments, similar to the display of the candidate point of interest, when the user selects the tab corresponding to the specific topic, the topic indication information 233 of the point of interest under the topic may also include historical interaction information related to the point of interest, a participation state of the first topic related to the point of interest, or attribute information of the point of interest. By way of example, if the point of interest is "bookstore A", the topic indication information 233 related to the point of interest may include the name of the bookstore (that is, bookstore A), the number of people participating in the first activity corresponding to the first topic in the bookstore, and the historical records and progress of the current user participating in the first activity corresponding to the first topic in the bookstore A. In some embodiments, the topic indication information may include a sub-topic related to the point of interest in the first topic. By way of example, if the first topic is a "coffee check-in point", it may include sub-topics of "type A coffee check-in point" and "type B coffee check-in point".

In some embodiments, if it is detected that the user selects a point of interest mark of the at least one point of interest mark, a third interface related to the point of interest mark is presented. For example, in the map view, each point of interest mark 232 and/or the topic indication information 233 may be configured as an entry to the activity detail interface corresponding to the topic related to the point of interest. If it is detected that the user triggers (for example, clicks on) the point of interest mark and/or the topic indication information, the third interface related to the point of interest mark is presented.

As shown in FIG. 2D, the third interface may be superimposed and presented on the first interface. The third interface shown in the example interface 200D at least presents multiple pieces of media content related to the first topic, and the media content is associated with the point of interest corresponding to the point of interest mark. By way of example, if the first topic is "flower viewing", and the point of interest is G park, the presented media content is an image or a video of a flower viewing activity related to the G park. As shown in FIG. 2D, the example interface 200D includes first media content 240-1, second media content 240-2, and third media content 240-3, which may be collectively or individually referred to as media content 240. In some embodiments, the media content presented in the interface related to the point of interest mark may be the content posted by the user in the process of interacting with the point of interest. If it is detected that the third interface is presented, the media content 240 in the third interface is automatically played. The user may update the played media content 240 through a gesture operation (for example, swiping left). In some embodiments, the third interface also presents attribute information 241 (for example, the location of the point of interest, the name of the point of interest, and the evaluation of the point of interest) of the point of interest, topic information 242 of the first topic, and an entry 243 for posting media content related to the first topic. The topic information 242 of the first topic may indicate activity information of the first activity corresponding to the first topic. By way of example, if the point of interest is holiday hotel F, the third interface presents the location of the hotel, the rating of the hotel, and the media content of participating in the first topic in the holiday hotel F, the rules for participating in the first topic, and the entry for participating in the first topic (for example, posting media content).

In some embodiments, although not specifically shown in the drawings, when presenting the candidate point of interest mark of FIG. 2A, if the selection of the candidate point of interest mark is detected, the third interface related to the candidate point of interest mark may also be presented, and the information type presented in this interface may be similar to the information type shown in FIG. 2D. In some embodiments, if it is detected in FIG. 2B that the second interaction element 221 related to the first topic currently selected is triggered, the interface related to the topic may also be presented, and the information type presented in this interface may be similar to the information type shown in FIG. 2C.

The above embodiments disclose the process of presenting the point of interest to the user according to the user's operation of selecting the tab in the first interface of the application 120 when the user triggers to view the first interface in the application 120. In some embodiments, the user may view the corresponding point of interest by scanning a graphic code (for example, a QR code, a barcode, or other codes with identification effect). As shown in FIG. 2E, the user may participate in the topic by scanning a graphic code 260. In some embodiments, the graphic code 260 may include a first type of graphic code associated with a certain topic, or may be a second type of graphic code associated with a certain point of interest.

In some embodiments, if it is detected that the user scans the graphic code 260, a loading interface may be presented to the user in the process of loading the corresponding interface. As shown in FIG. 2F, the loading interface shown in the example interface 200F includes a map view and a topic identification 270. The topic identification 270 is used to represent the topic (for example, activity 1) corresponding to the graphic code. In this manner, the user experience is further improved.

In some embodiments, if the first type of graphic code identifies a second topic, and if it is detected that the user scans the first type of graphic code with the terminal device 110, the first interface having a plurality of tabs is presented. In the first interface, the second tab corresponding to the second topic is in a default selected state. Then, at least one candidate point of interest mark associated with the second topic is presented in the map view. The point of interest mark associated with the second topic indicates a point of interest that participates in the second topic or a sub-topic of the second topic. As shown in FIG. 2G, if the first type of graphic code identifies the activity 1, the first interaction element 220 related to the activity 1 and a plurality of candidate point of interest marks 230 related to the activity 1 are presented in the interface 200G. In some embodiments, the plurality of candidate point of interest marks 230 may be presented in different forms. By way of example, the location information corresponding to the first type of graphic code may be determined based on the location where the terminal device is located when scanning the graphic code 260. Then, a first target point of interest mark closest to the location information is determined from the plurality of candidate point of interest marks 230 based on the determined location information. The first target point of interest mark is highlighted in the map view. For other points of interest in the map view, each point of interest mark may be presented in descending order of their distance from each point of interest to the first target point of interest mark. In this manner, it is more convenient for the user to view the points of interest near the location.

In some embodiments, if the user's scanning operation for a second type of graphic code is detected, a fourth interface 200D related to a second target point of interest identified by the second type of graphic code is presented. By way of example, if the second type of graphic code identifies the holiday hotel F participating in a third activity corresponding to a third topic, an interface related to the holiday hotel F is presented after the graphic code is scanned. This interface includes the media content related to the hotel and the third topic.

In some embodiments, if it is detected that the user selects a specific control related to historical interaction, such as a "my footprint" control, a fifth interface corresponding to the control is presented. As shown in FIG. 3A, the fifth interface represented by the example interface 300A includes a plurality of historical interaction points of interest determined based on the user's historical interaction operations. The example interface 300A includes a first historical tab 310-1, a second historical tab 310-2, and a third historical tab 310-3, which may be collectively or individually referred to as a historical tab 310. Different historical tabs correspond to different topics. By way of example, the first historical tab 310-1 may represent a historical interaction point of interest related to the first topic. The example interface 300A includes a first historical interaction point of interest 320-1, a second historical interaction point of interest 320-2, and a third historical interaction point of interest 320-3, which may be collectively or individually referred to as a historical interaction point of interest 320.

The historical interaction point of interest 320 indicates a point of interest at which the user has previously performed an interaction operation, and may be determined based on the user's historical interaction information. The historical interaction information may include historical interaction operations such as participation, check-in, collection, and evaluation of the topic corresponding to a certain point of interest.

In some embodiments, the virtual resource related to respective historical interaction point of interest may also be presented in association with respective historical point of interest mark. The example interface 300A includes a first virtual resource 330-1, a second virtual resource 330-2, and a third virtual resource 330-3, which may be collectively or individually referred to as a virtual resource 330. The number of the historical tab 310, the historical interaction point of interest 320, and the virtual resource 330 shown in the example interface 300A is only illustrative and not intended to be any limitation. In some embodiments, the resource amount of the virtual resource provided by different points of interest is determined based on the historical interaction information corresponding to respective historical interaction point of interest 320. By way of example, if the topic related to the historical interaction point of interest 320-1 is participated in, a first number of virtual resources may be provided, and if the evaluation operation is performed at the historical interaction point of interest 320-1, a second number of virtual resources may be provided. In some embodiments, the resource amount of the virtual resource may also be determined based on the influence of the user on the historical interaction point of interest 320-1.By way of example, if the number of times that the user's evaluation of the historical interaction point of interest 320-1 is adopted exceeds a threshold number of times, a third number of virtual resources are provided.

In some embodiments, the user may manually trigger to obtain the virtual resource provided by respective historical interaction point of interest 230. By way of example, if it is detected that a historical point of interest mark of the at least one historical point of interest mark is triggered, the virtual resource related to the historical point of interest is associated with the user account of the user. In some embodiments, the user may also be provided with a control for triggering virtual resource collection. As shown in FIG. 3B, the example interface 300B includes a control 340. If it is detected that the control 340 for triggering virtual resource collection is selected, the virtual resources related to all historical interaction points of interest are associated with the user account of the user at one time, thereby improving the collection efficiency. In some embodiments, the collection effect may be presented after the user selects the control 340. As shown in FIG. 3C, the collection effect may include the location movement of the virtual resource, the presentation of the dynamic effect in the interface, etc.

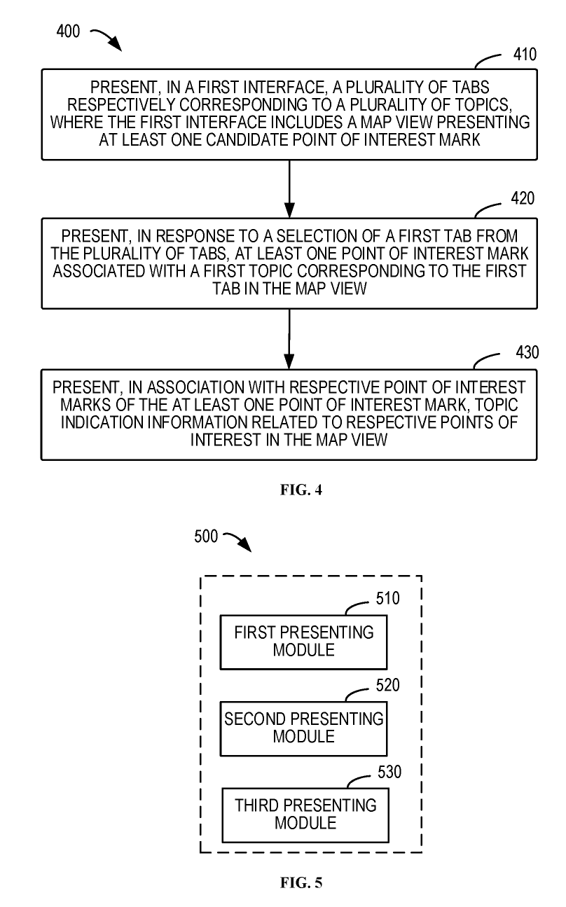

FIG. 4 shows a flowchart of an example process 400 for information interaction according to some embodiments of the present disclosure. The process 400 may be implemented at the terminal device 110. The process 400 is described below with reference to FIG. 1.

As shown in FIG. 4, at block 410, the terminal device 110 presents, in a first interface, a plurality of interface elements respectively corresponding to a plurality of content items, where the first interface includes a map view presenting at least one candidate object.

In some embodiments, the process 400 further includes: presenting, in association with respective candidate objects, content item indication information related to respective candidate points of interest in the map view, in response to the at least one candidate object being presented in the map view.

In some embodiments, presenting, in the first interface, the plurality of interface elements respectively corresponding to the plurality of content items includes: presenting, in response to a scanning operation for a first type of graphic code, the first interface having the plurality of interface elements, where the first type of graphic code identifies a second content item, and a second interface element corresponding to the second content item being in a default selected state in the first interface; and presenting, in the map view, the at least one candidate object associated with the second content item.

In some embodiments, presenting the at least one object associated with the second content item includes: determining location information corresponding to the first type of graphic code; determining, from the at least one object associated with the second content item, a first object adjacent to the location information; and highlighting, in the map view, the first object.

At block 420, the terminal device 110 presents, in response to a selection of a first interface element from the plurality of interface elements, at least one object associated with a first content item corresponding to the first interface element in the map view.

At block 430, the terminal device 110 presents, in association with respective objects of the at least one object, content item indication information related to respective points of interest in the map view.

In some embodiments, the content item indication information related to each object indicates at least one of: historical interaction information related to the object, a sub-content item related to the object in the first content item, a participation state of the first content item related to the object, or attribute information of the object.

In some embodiments, the process 400 further includes presenting, in response to a view request for the first interface, the first interface and a first interaction element related to a predetermined content item, where a plurality of objects associated with the predetermined content item are presented in the map view; and presenting, in response to a trigger on the first interaction element, a second interface related to the predetermined content item, the second interface including at least detailed information for the predetermined content item.

In some embodiments, the process 400 further includes updating, in response to detecting the selection of the first interface element from the plurality of interface elements, the first interaction element to a second interaction element related to the first content item in the first interface.

In some embodiments, the process 400 further includes presenting a third interface related to the object, in response to a selection of the object from the at least one object, at least media content related to the first content item being at least presented in the third interface, the media content being associated with an object corresponding to the object.

In some embodiments, at least one of the following is further presented in the third interface: attribute information of the object, content item information of the first content item, or an entry for posting media content related to the first content item.

In some embodiments, the process 400 further includes determining a theme style corresponding to the first content item, in response to selection of the first interface element; and updating a presentation style of the first interface based on the theme style corresponding to the first content item.

In some embodiments, the process 400 further includes presenting, in response to a scanning operation for a second type of graphic code, a fourth interface related to a second object identified by the second type of graphic code, where the fourth interface at least presents media content related to a third content item, the second object being associated with the third content item.

In some embodiments, the process 400 further includes presenting at least one historical interaction object in a map view of a fifth interface, where the at least one historical interaction object is determined based on historical interaction information of the user; and presenting, in association with respective historical objects, virtual resources related to respective historical interaction points of interest, where a resource amount of the virtual resources is determined based on the historical interaction information corresponding to respective historical interaction points of interest.

In some embodiments, the process 400 further includes associating, tin response to a trigger on a historical object of the at least one historical object, a virtual resource related to the historical object with a user account of the user; or associating virtual resources related to respective historical interaction points of interest with the user account of the user, in response to a selection of a control for triggering virtual resource acquisition.

The embodiments of the present disclosure also provide a corresponding apparatus for implementing the above method or process. FIG. 5 shows a schematic structural block diagram of an example apparatus 500 for information interaction according to some embodiments of the present disclosure. The apparatus 500 may be implemented as or included in the terminal device 110. Each module/component in the apparatus 500 may be implemented by hardware, software, firmware, or any combination thereof.

As shown in FIG. 5, the apparatus 500 includes a first presenting module 510 configured to present, in a first interface, a plurality of interface elements respectively corresponding to a plurality of content items, where the first interface includes a map view presenting at least one candidate object. The apparatus 500 includes a second presenting module 520 configured to present, in response to a selection of a first interface element from the plurality of interface elements, at least one object associated with the first content item corresponding to the first interface element in the map view. The apparatus 500 also includes a third presenting module 530 configured to present, in association with respective objects of the at least one object, content item indication information related to a respective object in the map view.

In some embodiments, the apparatus 500 further includes a content item indication information presenting module configured to present, in the map view and in association with a respective candidate object, content item indication information related to a respective candidate object, in response to the at least one candidate object being presented in the map view.

In some embodiments, the first presenting module 510 is further configured to present, in response to a scanning operation for a first type of graphic code, the first interface having the plurality of interface elements, where the first type of graphic code identifies a second content item, and a second interface element corresponding to the second content item being in a default selected state in the first interface; and presenting, in the map view, at least one candidate object associated with the second content item.

In some embodiments, the first presenting module 510 is further configured to determine location information corresponding to the first type of graphic code; determine, from the at least one object associated with the second content item, a first object adjacent to the location information; and highlight, in the map view, the first object.

In some embodiments, the content item indication information related to each object indicates at least one of: historical interaction information related to the object, a sub-content item related to the object in the first content item, a participation state of the first content item related to the object, or attribute information of the object.

In some embodiments, the apparatus 500 further includes a detailed information presenting module configured to present, in response to a view request for the first interface, the first interface and a first interaction element related to a predetermined content item, where the plurality of objects associated with the predetermined content item are presented in the map view; and presenting, in response to a trigger on the first interaction element, a second interface related to the predetermined content item, the second interface at least including detailed information for the predetermined content item.

In some embodiments, the apparatus 500 further includes an updating module configured to update, in response to detecting the selection of the first interface element from the plurality of interface elements, the first interaction element to a second interaction element related to the first content item in the first interface.

In some embodiments, the apparatus 500 further includes an object presenting module configured to present a third interface related to the object in response to a selection of the object from the at least one object, media content related to the first content item being at least presented in the third interface, the media content being associated with a object corresponding to the object.

In some embodiments, at least one of the following is further presented in the third interface: attribute information of the object, content item information of the first content item, or an entry for posting media content related to the first content item.

In some embodiments, the apparatus 500 further includes a style updating module configured to determine a theme style corresponding to the first content item in response to selection of the first interface element; and update a presentation style of the first interface based on the theme style corresponding to the first content item.

In some embodiments, the apparatus 500 further includes a scanning module configured to present, in response to a scanning operation for a second type of graphic code, a fourth interface related to a second object identified by the second type of graphic code, where the fourth interface at least presents media content related to a third content item, the second object being associated with the third content item.

In some embodiments, the apparatus 500 further includes a virtual resource presenting module configured to present at least one historical interaction object in a map view of a fifth interface, where the at least one historical interaction object is determined based on historical interaction information of the user; and presenting, in association with respective historical object, virtual resources related to respective historical interaction points of interest, where a resource amount of the virtual resources is determined based on the historical interaction information corresponding to the respective historical interaction points of interest.

In some embodiments, the apparatus 500 further includes a virtual resource acquisition and presenting module configured to associate, in response to a trigger on a historical object of the at least one historical object, the virtual resource related to the historical object with a user account of the user ; or associate virtual resources related to respective historical interaction points of interest with the user account of the user, in response to a selection of a control for triggering virtual resource acquisition.

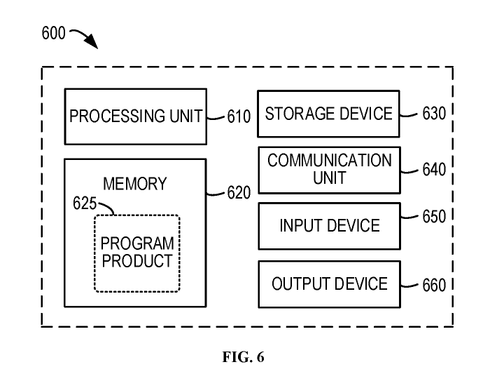

FIG. 6 shows a block diagram of an electronic device 600 capable of implementing multiple embodiments of the present disclosure. As shown in FIG. 6, the electronic device 600 is in the form of a general electronic device. The components of the electronic device 600 may include but are not limited to one or more processors or processing units 610, a memory 620, a storage device 630, one or more communication units 640, one or more input devices 650, and one or more output devices 660. The processing unit 610 may be an actual or virtual processor and may execute various processes based on the programs stored in the memory 620. In a multi-processor system, multiple processing units execute computer executable instructions in parallel to improve the parallel processing capability of the electronic device 600.

The electronic device 600 typically includes multiple computer storage medium. Such medium may be any available medium that is accessible to the electronic device 600, including but not limited to volatile and non-volatile medium, removable and non-removable medium. The memory 620 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 630 may be any removable or non-removable medium, and may include a machine-readable medium such as a flash drive, a disk, or any other medium, which may be used to store information and/or data and may be accessed within the electronic device 600.

The electronic device 600 may further include additional removable/non-removable, volatile/non-volatile memory medium. Although not shown in FIG. 6, it is possible to provide a disk driver for reading from or writing to a removable, non-volatile disk (such as a "floppy disk"), and an optical disk driver for reading from or writing to a removable, non-volatile optical disk. In these cases, each driver may be connected to the bus (not shown) by one or more data medium interfaces. The memory 620 may include a computer program product 625 having one or more program modules configured to perform various methods or acts of the various embodiments of the present disclosure.

The communication unit 640 enables communication with other electronic devices through the communication medium. Additionally, the functions of the components of the electronic device 600 may be implemented by a single computing cluster or multiple computing machines, which may communicate through communication connections. Therefore, the electronic device 600 may use a logical connection with one or more other servers, a network personal computer (PC) or another network node to operate in a networked environment.

The input device 650 may be one or more input devices, such as a mouse, a keyboard, a tracking ball, etc. The output device 660 may be one or more output devices, such as a display, a speaker, a printer, etc. The electronic device 600 may also communicate with one or more external devices (not shown) as needed through the communication unit 640, the external devices such as a storage device, a display device, etc., communicate with one or more devices that enable the user to interact with the electronic device 600, or communicate with any devices (for example, a network card, a modem, etc.) that enable the electronic device 600 to communicate with one or more other electronic devices. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is also provided a computer program product tangibly stored on a non-transitory computer-readable medium and including computer-executable instructions, which are executed by a processor to implement the method described above.

Various aspects of the present disclosure are described herein with reference to the flowcharts and/or block diagrams of the method, apparatus, device and computer program product implemented according to the present disclosure. It would be appreciated that each block of the flowcharts and/or block diagrams, and combinations of blocks in the flowcharts and/or block diagrams, may be implemented by computer-readable program instructions.

These computer-readable program instructions may be provided to a processing unit of a general-purpose computer, a special-purpose computer, or other programmable data processing apparatus to produce a machine, such that these instructions, when executed by the processing unit of the computer or other programmable data processing apparatus, produce an apparatus for implementing the functions/acts specified in one or more blocks of the flowcharts and/or block diagrams. These computer-readable program instructions may also be stored in a computer-readable storage medium, which instructions cause a computer, a programmable data processing apparatus, and/or other devices to work in a particular manner, such that the computer-readable medium storing the instructions includes a manufactured product, which includes instructions for implementing various aspects of the functions/acts specified in one or more blocks of the flowcharts and/or block diagrams.

The computer-readable program instructions may be loaded onto a computer, other programmable data processing apparatus, or other devices, such that a series of operating steps are performed on the computer, other programmable data processing apparatus, or other devices to produce a computer-implemented process, such that the instructions executed on the computer, other programmable data processing apparatus, or other devices implement the functions/acts specified in one or more blocks of the flowcharts and/or block diagrams.

The flowcharts and block diagrams in the drawings show the possibly implemented architectures, functions, and operations of the system, method and computer program product according to multiple implementations of the present disclosure. In this regard, each block in the flowchart or block diagram may represent a module, program segment, or part of an instruction, which includes one or more executable instructions for implementing the specified logical functions. In some alternative implementations, the functions marked in the blocks may also occur in an order different from that marked in the drawings. For example, two consecutive blocks may actually be executed substantially in parallel, or they may sometimes be executed in the reverse order, depending on the functions involved. It would also be noted that each block of the block diagrams and/or flowcharts, and combinations of blocks in the block diagrams and/or flowcharts, may be implemented by a special-purpose hardware-based system that perform the specified functions or acts, or may be implemented by a combination of special-purpose hardware and computer instructions.

The implementations of the present disclosure have been described above, and the above description is illustrative, non-exhaustive, and not limited to the disclosed implementations. Many modifications and variations will be apparent to those of ordinary skill in the art without departing from the scope and spirit of the described implementations. The terms used herein are chosen to best explain the principles of the implementations, the practical applications or improvements to the technology in the market, or to enable other persons of ordinary skill in the art to understand the implementations disclosed herein.

1. A method for information interaction, comprising:
presenting, in a first interface, a plurality of interface elements respectively corresponding to a plurality of content items, wherein the first interface comprises a map view presenting at least one candidate object;
presenting, in response to a selection of a first interface element from the plurality of interface elements, at least one object associated with a first content item corresponding to the first interface element in the map view; and
presenting, in association with respective objects of the at least one object, content item indication information related to respective points of interest in the map view.

2. The method of claim 1, further comprising:
presenting, in response to a view request for the first interface, the first interface and a first interaction element related to a predetermined content item, wherein the plurality of objects associated with the predetermined content item are presented in the map view; and
presenting, in response to a trigger on the first interaction element, a second interface related to the predetermined content item, the second interface at least comprising detailed information for the predetermined content item.

3. The method of claim 2, further comprising:
updating, in response to detecting the selection of the first interface element from the plurality of interface elements, the first interaction element to a second interaction element related to the first content item in the first interface.

4. The method of claim 1, further comprising:
presenting a third interface related to the object in response to a selection of an object from the at least one object, media content related to the first content item being at least presented in the third interface, the media content being associated with an object corresponding to the object.

5. The method of claim 4, wherein at least one of the following is further presented in the third interface:
attribute information of the object,
content item information of the first content item, or
an entry for posting media content related to the first content item.

6. The method of claim 1, further comprising:
determining a theme style corresponding to the first content item in response to selection of the first interface element; and
updating a presentation style of the first interface based on the theme style corresponding to the first content item.

7. The method of claim 1, wherein the content item indication information related to each object indicates at least one of:
historical interaction information related to the object,
a sub-content item related to the object in the first content item,
a participation state of the first content item related to the object, or
attribute information of the object.

8. The method of claim 1, further comprising:
presenting, in the map view and in association with a respective candidate object, content item indication information related to a respective candidate object, in response to the at least one candidate object being presented in the map view.

9. The method of claim 1, further comprising:
determining a content item rule related to the first content item, in response to the selection of the first interface element; and
presenting, in response to the content item rule indicating that the first content item matches a reference content item, one or more objects associated with the reference content item in the map view while the at least one object associated with the first content item is presented.

10. The method of claim 1, wherein presenting, in the first interface, the plurality of interface elements respectively corresponding to the plurality of content items comprises:
presenting, in response to a scanning operation for a first type of graphic code, the first interface having the plurality of interface elements, wherein the first type of graphic code identifies a second content item, and a second interface element corresponding to the second content item is in a default selected state in the first interface; and
presenting, in the map view, the at least one candidate object associated with the second content item.

11. The method of claim 10, wherein presenting the at least one object associated with the second content item comprises:
determining location information corresponding to the first type of graphic code;
determining, from the at least one object associated with the second content item, a first object adjacent to the location information; and
highlighting, in the map view, the first object.

12. The method of claim 1, further comprising:
presenting, in response to a scanning operation for a second type of graphic code, a fourth interface related to a second object identified by the second type of graphic code , wherein the fourth interface at least presents media content related to a third content item, the second object being associated with the third content item.

13. The method of claim 1, further comprising:
presenting at least one historical interaction object in the map view of a fifth interface, wherein the at least one historical interaction object is determined based on historical interaction information of a user; and
presenting, in association with respective historical objects, virtual resources related to respective historical interaction points of interest, wherein a resource amount of the virtual resources is determined based on the historical interaction information corresponding to the respective historical interaction points of interest.

14. The method of claim 13, further comprising:
associating, in response to a trigger on a historical object of the at least one historical object, a virtual resource related to the historical object with a user account of the user; or
associating virtual resources related to the respective historical interaction points of interest with the user account of the user, in response to a selection of a control for triggering virtual resource acquisition.

15. An electronic device, comprising:
at least one processor; and
at least one memory coupled to the at least one processor and storing instructions executable by the at least one processor, the instructions, when executed by the at least one processor, causing the electronic device to perform acts comprising:
presenting, in a first interface, a plurality of interface elements respectively corresponding to a plurality of content items, wherein the first interface comprises a map view presenting at least one candidate object;
presenting, in response to a selection of a first interface element from the plurality of interface elements, at least one object associated with a first content item corresponding to the first interface element in the map view; and
presenting, in association with respective objects of the at least one object, content item indication information related to respective points of interest in the map view.

16. The electronic device of claim 15, wherein the acts further comprise:
presenting, in response to a view request for the first interface, the first interface and a first interaction element related to a predetermined content item, wherein the plurality of objects associated with the predetermined content item are presented in the map view; and
presenting, in response to a trigger on the first interaction element, a second interface related to the predetermined content item, the second interface at least comprising detailed information for the predetermined content item.

17. The electronic device of claim 16, wherein the acts further comprise:
updating, in response to detecting the selection of the first interface element from the plurality of interface elements, the first interaction element to a second interaction element related to the first content item in the first interface.

18. The electronic device of claim 15, wherein the acts further comprise:
presenting a third interface related to the object mark in response to a selection of a object from the at least one object, media content related to the first content item being at least presented in the third interface, the media content being associated with a object corresponding to the object.

19. The electronic device of claim 18, wherein at least one of the following is further presented in the third interface:
attribute information of the object,
content item information of the first content item, or
an entry for posting media content related to the first content item.

20. A non-transitory computer-readable storage medium having a computer program stored thereon, the computer program being executable by a processor to implement acts comprising:
presenting, in a first interface, a plurality of interface elements respectively corresponding to a plurality of content items, wherein the first interface comprises a map view presenting at least one candidate object;
presenting, in response to a selection of a first interface element from the plurality of interface elements, at least one object associated with a first content item corresponding to the first interface element in the map view; and
presenting, in association with respective objects of the at least one object, content item indication information related to respective points of interest in the map view.
